(19) United States
(12) Patent Application Publication
(10) Pub. No.: US 2026/0221921 A1
(43) Pub. Date: Jul. 30, 2026

(54) WINDING SWITCHING SYSTEM, VEHICLE MOTOR DRIVE SYSTEM, CONTROL DEVICE, CONTROL METHOD, AND COMPUTER PROGRAM

(71) Applicants: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP)

(72) Inventor: Hiroki SASAKURA, Osaka-shi, Osaka (JP)

(73) Assignees: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP)

(21) Appl. No.: 19/148,582

(22) PCT Filed: Dec. 8, 2023
(86) PCT No.: PCT/JP2023/044063

§ 371 Date: Jul. 16, 2025

(30) Foreign Application Priority Data
Jan. 17, 2023 (JP) 2023-005012

(51) Int. Cl. H02P 25/22; H02P 27/06

(52) U.S. Cl. CPC H02P 25/22; H02P 27/06

(57) ABSTRACT

A winding switching system for, in a motor in which stators for respective phases each include a plurality of windings, switching a connection state of the plurality of windings, includes: a first relay that is set to ON when the connection state of the plurality of windings is a first connection state; a second relay that is set to OFF when the connection state of the plurality of windings is the first connection state; a first opening unit configured to set the first relay to OFF when switching the connection state from the first connection state to a second connection state; and a first connection unit that sets the second relay to ON after the elapse of a first predetermined period from when the first relay is set to OFF by the first opening unit.

### CROSS-REFERENCE TO RELATED APPLICATIONS

This application is the U.S. national stage of PCT/JP2023/044063 filed on Dec. 8, 2023, which claims priority of Japanese Patent Application No. JP 2023-005012, filed on Jan. 17, 2023, the contents of which are incorporated herein.

### TECHNICAL FIELD

The present disclosure relates to a winding switching system, a vehicle motor drive system, a control device, a control method, and a computer program.

### BACKGROUND

JP 2020-188597A discloses a variable-characteristic vehicle motor system in which a plurality of windings are switched by a plurality of relays to change a characteristic. In such a vehicle motor system, a plurality of windings of the motor are switched between series connection and parallel connection by a plurality of relays.

When a plurality of windings are switched between series connection and parallel connection, a plurality of relays used in the vehicle motor system disclosed in Patent Document 1 are switched at the same time. However, even if the relays are switched at the same timing, the time until when a relay is actually set to ON and the time until when the relay is actually set to OFF differs for each relay. For this reason, there may be a period during which the plurality of relays are simultaneously in the ON state. In this case, the windings may short-circuit, whereby there is a risk of the rotating rotor generating a large induced current, which may lead to contact sticking.

### SUMMARY

A winding switching system according to an aspect of the present disclosure is a winding switching system for, in a motor in which stators for respective phases each include a plurality of windings, switching a connection state of the plurality of windings, including: a first relay that is set to ON when the connection state of the plurality of windings is a first connection state; a second relay that is set to OFF when the connection state of the plurality of windings is the first connection state; a first opening unit configured to set the first relay to OFF when switching the connection state from the first connection state to a second connection state; and a first connection unit that sets the second relay to ON after the elapse of a first predetermined period from when the first relay is set to OFF by the first opening unit.

The present disclosure can be realized not only as a winding switching system having the above-described characteristic configuration, but also as a control device included in a winding switching system, or as a control method for a vehicle motor in which characteristic processing in a control device is used as steps. The present disclosure can be realized as a computer program that causes a computer to function as a control device, or a portion or all of the control device can be realized as a semiconductor integrated circuit.

### Advantageous Effects

According to the present disclosure, even if the connection state of the plurality of windings is switched by a plurality of relays, it is possible to prevent the relays from entering the ON state at the same time.

### BRIEF DESCRIPTION OF DRAWINGS

FIG. 1 is a diagram showing an example of a configuration of a winding switching system according to a first embodiment.

FIG. 2 is a block diagram illustrating an example of a hardware configuration of a control device.

FIG. 3 is a circuit diagram showing an example of the configuration of the winding switching device according to the first embodiment.

FIG. 4 is a flowchart showing an example of winding switching processing performed by the control device according to the first embodiment.

FIG. 5 is a timing chart showing an example of winding switching processing performed by the control device according to the first embodiment.

FIG. 6 is a circuit diagram of an example of a control circuit including a plurality of logic circuits.

FIG. 7 is a timing chart showing an example of operation of a winding switching device according to a second embodiment.

FIG. 8 is a circuit diagram showing an example of a configuration of a modified example of a winding switching device.

### DETAILED DESCRIPTION OF PREFERRED EMBODIMENTS

Hereinafter, an overview of the embodiments of the present disclosure will be listed and described.

(1) A winding switching system according to the present embodiment is A winding switching system for, in a motor in which stators for respective phases each include a plurality of windings, switching a connection state of the plurality of windings, including: a first relay that is set to ON when the connection state of the plurality of windings is a first connection state; a second relay that is set to OFF when the connection state of the plurality of windings is the first connection state; a first opening unit configured to set the first relay to OFF when switching the connection state from the first connection state to a second connection state; and a first connection unit that sets the second relay to ON after the elapse of a first predetermined period from when the first relay is set to OFF by the first opening unit. This makes it possible to prevent the relays from entering the ON state at the same time even when the connection state of the plurality of windings is switched from the first connection state to the second connection state by the plurality of relays.

(2) In (1) above, the first predetermined period may be longer than a reset time of the first relay. As a result, the first relay enters the OFF state electrically, and then the connection state is switched, whereby it is possible to reliably prevent the plurality of relays from entering the ON state at the same time.

(3) In (1) or (2) above, the winding switching system may further include: a second opening unit configured to set the second relay to OFF when switching the connection state from the second connection state to the first connection state; and a second connection unit configured to set the first relay to ON after the elapse of a second predetermined period from when the second relay is set to OFF by the second opening unit. This makes it possible to prevent the plurality of relays from entering the ON state at the same time, even when the connection state is switched from the second connection state to the first connection state.

(4) In (3) above, the second predetermined period may be longer than a reset time of the second relay. As a result, the second relay enters the OFF state electrically, and then the connection state is switched, whereby it is possible to reliably prevent the plurality of relays from entering the ON state at the same time.

(5) In any one of (1) to (4) above, the plurality of windings may include a first winding and a second winding, a first terminal of the first relay may be connected to a first terminal of the first winding, a second terminal of the first relay may be connected to a first terminal of the second winding, a first terminal of the second relay may be connected to the first terminal of the second winding, and a second terminal of the second relay may be connected to a second terminal of the first winding. This makes it possible to prevent the plurality of relays from entering the ON state at the same time, even if the connection state of the windings is switched between a first connection state in which two windings are connected in series and a second connection state in which one winding is connected.

(6) In (5) above, the winding switching system may further include a third relay that is set to ON when the connection state of the plurality of windings is the first connection state, a first terminal of the third relay may be connected to the second terminal of the first winding, a second terminal of the third relay may be connected to a second terminal of the second winding, and the first opening unit may set the third relay to OFF when switching the connection state from the first connection state to the second connection state. This makes it possible to prevent the plurality of relays from entering the ON state at the same time, even if the connection state of the windings is switched between a first connection state in which two windings are connected in series and a second connection state in which two windings are connected in parallel.

(7) In any one of (1) to (6) above, when a drive device configured to drive the motor suppresses a current that drives the motor, the first opening unit may set the first relay to OFF, and the first connection unit may set the second relay to ON. This allows the plurality of relays to be switched when the current flowing through the relays is low, thereby extending the life of the relays.

(8) In (3) or (4) above, when a drive device configured to drive the motor suppresses a current that drives the motor, the second opening unit may set the second relay to OFF, and the second connection unit may set the first relay to ON. This allows the plurality of relays to be switched when the current flowing through the relays is low, thereby extending the life of the relays.

(9) A vehicle motor drive system according to the present embodiment includes: an AC motor in which stators for respective phases each include a plurality of windings, the AC motor being configured to drive wheels of a vehicle; a power converter configured to convert DC power into three-phase AC power for driving the AC motor; and the winding switching system according to any one of (1) to (8) above, configured to switch a connection state of the plurality of windings. This makes it possible to prevent the plurality of relays from entering the ON state at the same time, even in a vehicle equipped with a winding switching device that switches the connection state of the windings of an AC motor that drives the wheels of the vehicle.

(10) A control device according to the present embodiment is a control device for controlling a winding switching device that includes a first relay and a second relay and is for, in a motor in which stators for respective phases each include a plurality of windings, switching a connection state of the plurality of windings, including: an opening unit configured to set the first relay that is set to ON when the connection state of the plurality of windings is a first connection state, to OFF when switching from the first connection state to a second connection state; and a connection unit configured to set the second relay that is set to OFF when the connection state of the plurality of windings is the first connection state, to ON after the elapse of a predetermined period from when the first relay is set to OFF. As a result, the control device that controls the winding switching device that switches the connection state of the windings can prevent the plurality of relays from entering the ON state at the same time.

(11) A control method according to the present embodiment is a control method for controlling a winding switching device that includes a first relay and a second relay and is for, in a motor in which stators for respective phases each include a plurality of windings, switching a connection state of the plurality of windings, including: a step of setting the first relay that is set to ON when the connection state of the plurality of windings is a first connection state, to OFF when switching from the first connection state to a second connection state; and a step of setting the second relay that is set to OFF when the connection state of the plurality of windings is the first connection state, to ON after the elapse of a predetermined period from when the first relay is set to OFF. This makes it possible to prevent the plurality of relays from entering the ON state at the same time, even when the connection state of the plurality of windings is switched by the plurality of relays.

(12) A computer program according to the present embodiment is a computer program used by a control device for controlling a winding switching device for, in a motor in which stators for respective phases each include a plurality of windings and a connection state of the plurality of windings can be switched, switching the connection state of the plurality of windings using a first relay and a second relay, the computer program being used to cause a computer to execute: a step of setting the first relay that is set to ON when the connection state of the plurality of windings is a first connection state, to OFF when switching from the first connection state to a second connection state, and a step of setting the second relay that is set to OFF when the connection state of the plurality of windings is the first connection state, to ON after the elapse of a predetermined period from when the first relay is set to OFF. This makes it possible to prevent the plurality of relays from entering the ON state at the same time, even when the connection state of the plurality of windings is switched by the plurality of relays.

Hereinafter, details of embodiments of the present disclosure will be described with reference to the drawings. Note that at least some of the embodiments described below may be combined in any manner.

### 1. First Embodiment

### 1-1. Winding Switching System

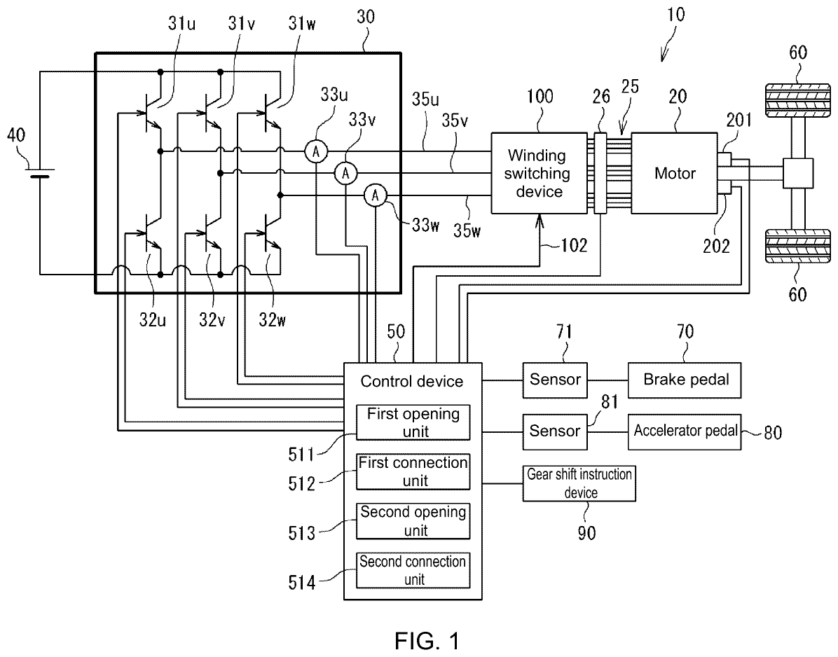

FIG. 1 is a diagram showing an example of a configuration of a winding switching system according to a first embodiment.

The winding switching system 10 is mounted on a vehicle propelled by a motor, such as an electric vehicle or a plug-in hybrid vehicle (hereinafter, referred to as an “electric vehicle”). The winding switching system 10 includes a motor 20, a power converter 30, a battery 40, a control device 50, and a winding switching device 100.

The motor 20 is a travel motor that generates propulsive force for the electric vehicle. That is, the motor 20 is a drive motor that is connected to wheels 60 and drives the wheels 60. The motor 20 is driven by three-phase AC power. For example, the motor 20 is a non-commutator-type AC motor that does not have a commutator, but drives a stator with three-phase AC power to generate a rotating magnetic field, and the rotating magnetic field rotates a rotor. Non-commutator-type AC motors include, for example, synchronous motors, reluctance motors, and induction motors.

The battery 40 is a battery for supplying power to drive the motor 20. The battery 40 is a secondary battery, and for example, a lithium ion battery.

The power converter 30 is an inverter that converts DC power supplied from the battery 40 into three-phase AC power. The power converter 30 may have a function of converting three-phase AC power output when the motor 20 functions as a generator into DC power and charging the battery 40.

The power converter 30 includes a leg for each of a U-phase, a V-phase, and a W-phase. The U-phase leg includes switches 31u and 32u, the V-phase leg includes switches 31v and 32v, and the W-phase leg includes switches 31w and 32w. The switches 31u, 32u, 31v, 32v, 31w, and 32w perform switching, thereby converting the DC power into three-phase AC power. The switches 31u, 32u, 31v, 32v, 31w, and 32w are, for example, insulated gate bipolar transistors (IGBTs) or metal oxide semiconductor field-effect transistors (MOSFETs).

A power line 35u corresponding to the U-phase extends from the U-phase leg, a power line 35v corresponding to the V-phase extends from the V-phase leg, and a power line 35w corresponding to the W-phase extends from the W-phase leg. In the power converter 30, a current sensor 33u is provided on the power line 35u, a current sensor 33v is provided on the power line 35v, and a current sensor 33w is provided on the power line 35w. The current sensor 33u detects the current value of a U-phase current Iu. The current sensor 33v detects the current value of a V-phase current Iv. The current sensor 33w detects the current value of a W-phase current Iw. The current sensors 33u, 33v, and 33w can detect the current values of the currents Iu, Iv, and Iw, including the DC and AC components, flowing through the power lines 35u, 35v, and 35w. The current sensors 33u, 33v, and 33w are, for example, DC current sensors (direct current sensors) using Hall sensors or shunt resistors.

The winding switching device 100 is disposed between the motor 20 and the power converter 30. The power converter 30 and the winding switching device 100 are connected by the power lines 35u, 35v, and 35w, and the winding switching device 100 and the motor 20 are connected by a plurality of power lines 25. The winding switching device 100 switches the connection state of a plurality of windings of the motor 20. The configuration of the winding switching device 100 will be described later. The three-phase AC currents Iu, Iv, and Iw output from the power converter 30 are supplied to the motor 20 via the winding switching device 100.

A measurement unit 26 measures a state of the motor 20. An example of a state of the motor is the current flowing through each winding of the motor 20, but there is no limitation to the current. The measurement unit 26 is provided at a location corresponding to the measurement target. When measuring the current in the power lines connecting the winding switching device 100 and the motor 20, the measurement unit 26 is provided on the power lines 212u, 221u, 212v, 221v, 212w, and 221w between the measurement unit 26 and the motor 20. The current is measured by, for example, a DC current sensor using a Hall sensor.

The control device 50 controls the motor 20. Specifically, the control device 50 controls the motor 20 by controlling the power converter 30 and the winding switching device 100. Signal lines extend from the control device 50 to the respective switches 31u, 32u, 31v, 32v, 31w, and 32w, and the control device 50 controls the timing of the switching ON and OFF of the switches 31u, 32u, 31v, 32v, 31w, and 32w. A signal line extends from the control device 50 to the winding switching device 100, and the control device 50 outputs a switching command signal for commanding the switching of the connection state of the windings to the winding switching device 100.

The control device 50 is connected to a sensor 71 that detects a depression amount of a brake pedal 70, and receives a detection signal output from the sensor 71. The control device 50 is connected to a sensor 81 that detects a depression amount of an accelerator pedal 80, and receives a detection signal output from the sensor 81.

A rotation sensor 201 for detecting the rotation speed of the motor 20 and a torque sensor 202 for detecting the output torque of the motor 20 are attached to the output shaft of the motor 20. The rotation sensor 201 and the torque sensor 202 are connected to the control device 50. The control device 50 receives a detection signal output from the rotation sensor 201 and a detection signal output from the torque sensor 202.

The control device 50 is connected to a gear shift instruction device 90. The gear shift instruction device 90 is an input device that allows the driver to input a gear shift instruction. The gear shift instruction device 90 is, for example, a shift lever. In another example, the gear shift instruction device 90 is a switch for the driver to instruct an upshift or a downshift. The gear shift instruction device 90 outputs a gear shift instruction signal in response to an operation by the driver. The control device 50 receives a gear shift instruction signal output from the gear shift instruction device 90.

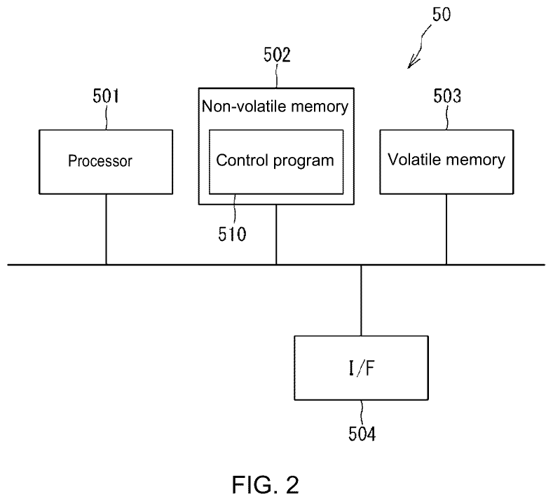

FIG. 2 is a block diagram illustrating an example of a hardware configuration of the control device. The control device 50 includes a processor 501, a non-volatile memory 502, a volatile memory 503, and an interface (I/F) 504.

The volatile memory 503 is a semiconductor memory such as a static random access memory (SRAM) or a dynamic random access memory (DRAM). The non-volatile memory 502 is, for example, a flash memory, a hard disk, or a Read Only Memory (ROM). The non-volatile memory 502 stores a control program 510, which is a computer program, and data used for executing the control program 510. Each function of the control device 50 is realized by the processor 501 executing the control program 510. The control program 510 can be stored in a recording medium such as a flash memory, a ROM, or a CD-ROM. The processor 501 controls the power converter 30 and the winding switching device 100 according to the control program 510.

The processor 501 is, for example, a central processing unit (CPU). However, the processor 501 is not limited to a CPU. The processor 501 may be a graphics processing unit (GPU). The processor 501 is, for example, a multi-core processor. The processor 501 may be a single-core processor. The processor 501 may be, for example, an application specific integrated circuit (ASIC), or a programmable logic device such as a gate array or a field programmable gate array (FPGA). In this case, the ASIC or programmable logic device is configured to be able to execute the same processing as the control program 510.

The I/F 504 is connected to the rotation sensor 201, the torque sensor 202, the sensor 71, the sensor 81 and the gear shift instruction device 90. The I/F 504 is, for example, an input/output interface or a communication interface. The I/F 504 receives a detection signal of the rotation speed of the motor 20 output from the rotation sensor 201. The I/F 504 receives a detection signal of the output torque of the motor 20 output from the torque sensor 202. The I/F 504 receives a detection signal of the depression amount of the brake pedal output from the sensor 71. The I/F 504 receives a detection signal of the depression amount of the accelerator pedal output from the sensor 81. The I/F 504 receives a gear shift instruction signal output from the gear shift instruction device 90.

### 1-2. Configuration of Winding Switching Device

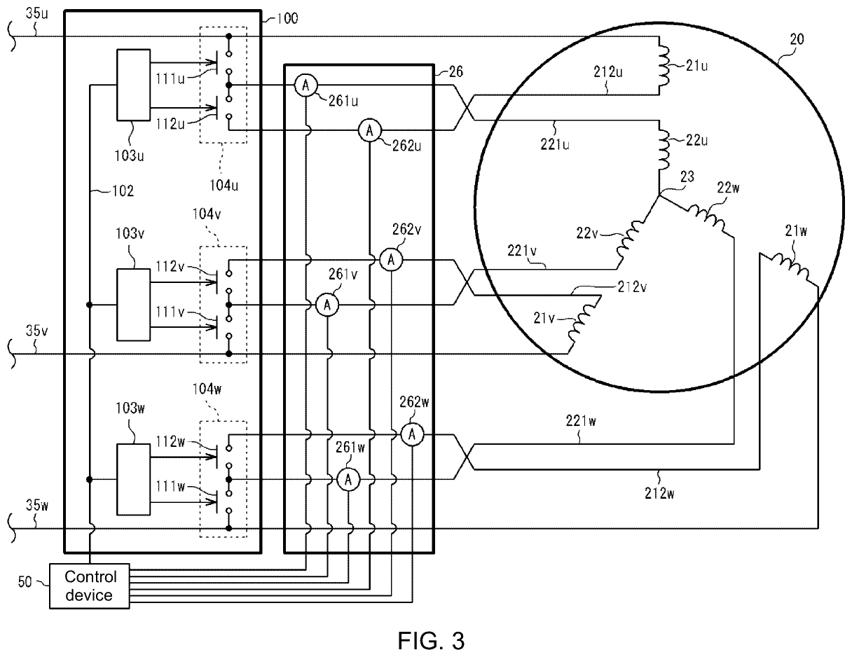

FIG. 3 is a circuit diagram showing an example of a configuration of the winding switching device according to the first embodiment. The motor 20 includes a plurality of windings 21u, 22u. 21v, 22v, 21w, and 22w. The windings 21u and 22u correspond to the U-phase, the windings 21v and 22v correspond to the V-phase, and the windings 21w and 22w correspond to the W-phase. However, the number of windings for each phase is not limited to two, and may be three or more. The windings 22u, 22v, and 22w are connected at a neutral point 23.

The winding switching device 100 switches the connection states of the windings 21u, 22u, 21v, 22v, 21v, and 22w for each phase between a first connection state and a second connection state. The winding switching device 100 includes control circuits 103u, 103v, and 103w, and switching circuits 104u, 104v, and 104w.

Under the control of the control device 50, the switching circuits 104u, 104v, and 104w switch the connection state of the windings 21u, 22u, 21v, 22v, 21w, and 22w between a state in which two windings are connected in series and a state in which one winding is connected. For example, in the U-phase, the state in which two windings are connected in series is a state in which a first terminal of the winding 21u is connected to the power line 35u, a second terminal is connected to a first terminal of the winding 22u via a relay 112u, and a second terminal of the winding 22u is connected to the neutral point 23. On the other hand, the state in which one winding is connected, is a state in which the first terminal of the winding 22u is connected to the power line 35u via a relay 111u, and the second terminal of the winding 22u is connected to the neutral point 23. The same applies to the V-phase and the W-phase as well. The state in which two windings are connected in series is an example of the first connection state. Also, the state in which one winding is connected is an example of the second connection state.

The connection relationship between the winding switching device 100, the power line 35u, and the motor 20 will be described below as a representative for the U-phase. The V-phase and W-phase are similar, and therefore the description will be omitted.

The power line 35u is connected to a first terminal of the winding 21u. A power line 212u extends from the second terminal of the winding 21u. A power line 221u extends from the first terminal of the winding 22u.

The switching circuit 104u includes the relays 111u and 112u. The relays 111u and 112u are, for example, mechanical (electromagnetic) relays. However, there is no limitation to this, and the relays 111u and 112u may be semiconductor relays. The relays are divided into an input side and an output side. In the case of a mechanical relay, for example, the input side is constituted by an electromagnetic coil, and the output side is constituted by a contact. In the case of a semiconductor relay, for example, the input side is constituted by a light-emitting diode, and the output side is constituted by a light-receiving element, a MOSFET, and an IGBT. When a predetermined control signal is input to the input side of a relay, the output side is set to ON or OFF.

The power line 35u is led into the winding switching device 100. In the winding switching device 100, the power line 35u branches off at an intermediate point and is connected to the first terminal of the relay 111u. The second terminal of the relay 111u is connected to the first terminal of the relay 112u. The power lines 212u and 221u extend from the motor 20 and are led into the winding switching device 100. The power line 221u extending from the winding 22u is connected to a connection point between the second terminal of the relay 111u and the first terminal of the relay 112u. The second terminal of the relay 112u is connected to the power line 212u extending from the winding 21u.

When the relay 111u is in an OFF state and the relay 112u is in an ON state, the windings 21u and 22u are in the first connection state. When the relay 111u is in the ON state and the relay 112u is in the OFF state, the winding 21u is in the second connection state.

A communication line extending from the control circuit 103u is connected to each of the input sides (electromagnetic coil sides) of the relays 112u and 111u. A communication line 102 extending from the control device 50 is connected to the control circuit 103u. The control device 50 transmits, via the communication line 102, a switching signal SS that indicates which connection state of the windings is to be set. For example, the switching signal SS indicates being set to the first connection state when it is at a LOW level, and indicates being set to the second connection state when it is at a HIGH level. Alternatively, the switching signal SS may be data including information indicating which relays to set to ON or OFF. Here, the LOW level is, for example, the potential of the body of the vehicle, and the HIGH level is, for example, the potential of the power source supplied to the control device 50.

The control circuit 103u sets the relays 112u and 111u to ON or OFF by applying control signals to the input sides of the relays 112u and 111u, respectively. Specifically, when the control circuit 103u receives a HIGH-level switching signal SS for switching the connection state of the windings 21u and 22u from the first connection state to the second connection state from the control device 50, the control circuit 103u sets the relay 111u to the ON state and the relay 112u to the OFF state. When the control circuit 103u receives a LOW-level switching signal SS switching the connection state of the windings 21u and 22u from the second connection state to the first connection state from the control device 50, the control circuit 103u sets the relay 111u to the OFF state and the relay 112u to the ON state.

The control circuit 103u is constituted by, for example, a plurality of logic circuits (AND circuits, NOT circuits, latch circuits, etc.). In another example, the control circuit 103u is constituted by a processor. For example, the control circuit 103u is constituted by a one-chip microcomputer. The control circuit 103u may be constituted by a programmable logic device such as an ASIC or an FPGA.

A measurement unit 26 including a phase current sensor and a relay current sensor is provided on the power line connecting the winding switching device 100 and the motor 20. A phase current sensor 261u is provided on the power line 221u, and a relay current sensor 262u is provided on the power line 212u. The phase current sensor 261u detects the current flowing through the U-phase when the windings 21u and 22u are in the first connection state and the second connection state. Hereinafter, the current detected by the phase current sensor is referred to as a phase current in some cases. The relay current sensor 262u detects the current flowing through the power line 212u connected to a second terminal of the relay 112u. When the connection state of the windings 21u and 22u is switched from the first connection state to the second connection state, the relay current sensor 262u detects the current in the power line 212u that is to be interrupted by the relay 112u that is set to OFF. Hereinafter, the current detected by the relay current sensor is referred to as a relay current in some cases. Similarly, for the V-phase as well, a phase current sensor 261v is provided on the power line 221v, and a relay current sensor 262v is provided on the power line 212v. For the W-phase as well, a phase current sensor 261w is provided on the power line 221w, and a relay current sensor 262w is provided on the power line 212w.

### 1-3. Functions of Control Device

Returning to FIG. 1, the functions of the control device 50 will be described. The control device 50 has the functions of a first opening unit 511, a first connection unit 512, a second opening unit 513, and a second connection unit 514. Due to the processor 501 executing the control program 510, the functions of the first opening unit 511, the first connection unit 512, the second opening unit 513, and the second connection unit 514 are realized. Although description will be given for only the U-phase below, the same applies to the V-phase and the W-phase as well. An example will be described below in which the connection state is switched from the first connection state to the second connection state, and then switched from the second connection state to the first connection state.

### 1-3-1. First Opening Unit

When switching the connection state from the first connection state to the second connection state, the first opening unit 511 sets the first relay that is set to ON when the connection state is the first connection state, to OFF.

Since the initial state is the first connection state, the relay 111u is set to OFF and the relay 112u is set to ON. Specifically, the control device 50 transmits a switching signal SS indicating that the relay 111u is to be set to OFF and the relay 112u is to be set to ON, to the control circuit 103u. Upon receiving the switching signal SS, the control circuit 103u sets the relay 111u of the switching circuit 104u to OFF and sets the relay 112u to ON.

Since the first relay that is set to ON in the first connection state is the relay 112u, when switching the connection state of the windings from the first connection state to the second connection state, the first opening unit 511 transmits a switching signal SS indicating that the relay 112u that is set to ON in the first connection state is to be set to OFF, to the control circuit 103u. Upon receiving the switching signal SS, the control circuit 103u sets the relay 112u of the switching circuit 104u to OFF.

### 1-3-2. First Connection Unit

After the elapse of a first predetermined period Dt1 from when the first relay is set to OFF, the first connection unit 512 sets the second relay that was set to OFF in the first connection state, to ON.

First, the first opening unit 511 sets the relay 112u to OFF, and then the first connection unit 512 waits for the first predetermined period Dt1. More specifically, for example, if the control device 50 has a timer, the first connection unit 512 sets a value representing the first predetermined period Dt1 in the timer and starts the timer. The timer value is decremented every 1 ms, for example, and the first connection unit 512 waits until the timer value becomes zero. After the timer value reaches zero, the first connection unit 512 sets the second relay that is set to OFF in the first connection state, to ON.

Since the second relay that is set to OFF in the first connection state is the relay 111u, the first connection unit 512 transmits a switching signal SS indicating that the relay 111u is to be set to ON, to the control circuit 103u. Upon receiving the switching signal SS, the control circuit 103u sets the relay 111u to OFF. As a result, the connection state of the windings 21u and 22u is set to the second connection state.

### 1-3-3. Second Opening Unit

The second opening unit 513 sets the second relay to OFF when switching from the second connection state to the first connection state. The second relay is set to ON by the first connection unit.

When the connection state of the windings is switched from the second connection state to the first connection state, the second relay that was set to ON by the first connection unit is the relay 111u. Accordingly, when switching the connection state of the windings from the second connection state to the first connection state, the second opening unit 513 transmits a switching signal SS indicating that the relay 111u that was set to ON by the first connection unit 512 is to be set to OFF, to the control circuit 103u. Upon receiving the switching signal SS, the control circuit 103u sets the relay 111u of the switching circuit 104u to OFF.

### 1-3-4. Second Connection Unit

Next, the second connection unit 514 sets the first relay to ON after the elapse of a second predetermined period Dt2 from when the second relay is set to OFF.

After the second relay is set to OFF, that is, after the relay 111u is set to OFF, the second connection unit 514 waits for the second predetermined period Dt2. Then, after the elapse of the second predetermined period Dt2, the second connection unit 514 transmits a switching signal SS indicating that the relay 112u is to be set to ON, to the control circuit 103u. Upon receiving the switching signal SS, the control circuit 103u sets the relay 112u to ON. As a result, the connection state of the windings 21u and 22u is set to the first connection state.

Note that when the current flowing through the contact of the relay is small, the first opening unit 511 and the second opening unit 513 may set the relay to OFF. Setting the relay to OFF when the current flowing through the winding is small restricts arcing across the relay contacts, thereby extending the life of the relay. The current flowing through the relay can be measured, for example, by the relay current sensor 262u. Alternatively, the timing at which first opening unit 511 and the second opening unit 513 set the relay to OFF may be when the power converter 30 that drives the motor turns off or suppresses the current that drives the motor. Alternatively, the control device 50 may control the power converter 30 so as to reduce the current flowing through the windings, and then the first opening unit 511 and the second opening unit 513 may set the relays to OFF.

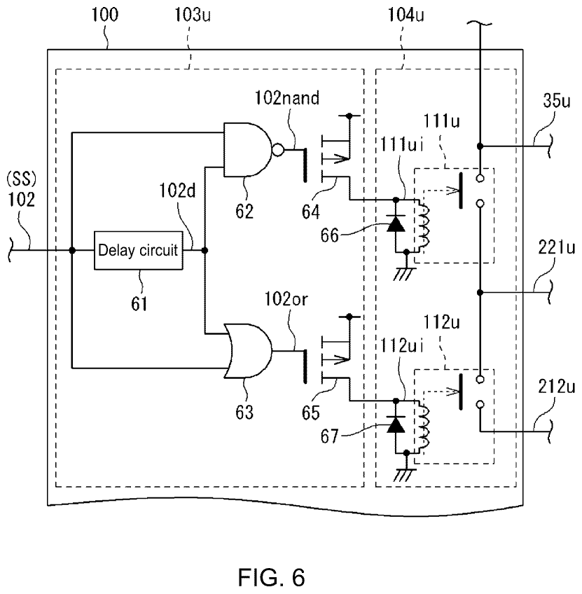

Note that the first predetermined period Dt1 and the second predetermined period Dt2 may be set to be longer than the reset time of the relays. This is because the relays enter the OFF state after the reset time has elapsed, and thus it is possible to prevent the relays from entering the ON state at the same time. The predetermined time is set to, for example, 20 ms. As shown in FIG. 6, which will be described later, a diode is connected in parallel to an electromagnetic coil of a relay in order to protect the driving element, such as a MOSFET, in some cases. When the current flowing through the electromagnetic coil is interrupted to turn OFF the relay, the energy stored in the electromagnetic coil is consumed as a current circulating through the electromagnetic coil via the diode. This causes the relay to remain in the ON state while the current is circulating. In such a case, the first predetermined period Dt1 and the second predetermined period Dt2 may be made longer than a time obtained by adding the time during which the current is circulating to the reset time determined by the specifications of the relay. The first predetermined period Dt1 and the second predetermined period Dt2 can be easily changed by rewriting the control program stored in the non-volatile memory 502.

Note that in the above example, the first opening unit 511, the first connection unit 512, the second opening unit 513, and the second connection unit 514 were described as being provided in the control device 50. However, the first opening unit 511, the first connection unit 512, the second opening unit 513, and the second connection unit 514 may also be provided in the control circuit 103u. In this case, the control circuit 103u is constituted by, for example, a one-chip microcomputer. Such a one-chip microcomputer includes, for example, a processor, anon-volatile memory, a volatile memory, and the like. A control program is stored in the non-volatile memory. The processor of the one-chip microcomputer executes the control program, whereby the functions of the first opening unit 511, the first connection unit 512, the second opening unit 513, and the second connection unit 514 are realized.

### 1-4. Operation of Winding Switching System

Next, the operation of the winding switching device 100 will be described. The control device 50 executes winding switching processing due to the processor 501 executing the control program 510.

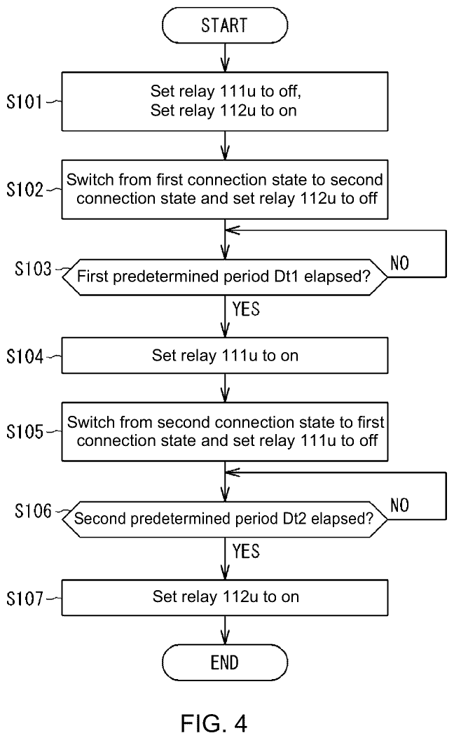

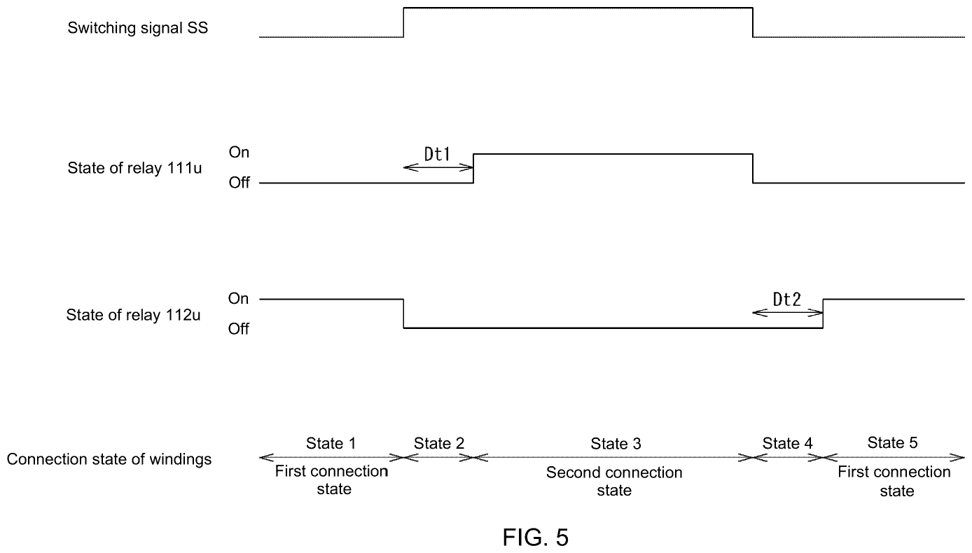

FIG. 4 is a flowchart showing an example of winding switching processing performed by the control device according to the first embodiment. FIG. 5 is a timing chart showing an example of the winding switching processing performed by the control device according to the first embodiment. An example will be described below in which the connection state of the windings is switched from the first connection state to the second connection state, and then switched from the second connection state to the first connection state.

### Step S101

Since the initial state is the first connection state, the relay 111u is set to OFF and the relay 112u is set to ON. Specifically, the control device 50 transmits a switching signal SS indicating that the relay 111u is to be set to OFF and the relay 112u is to be set to ON, to the control circuit 103u. Upon receiving the switching signal SS, the control circuit 103u sets the relay 111u to OFF and sets the relay 112u to ON (step S101). The position of state 1 in the timing chart shown in FIG. 5 indicates this state. When the relay 111u is set to OFF and the relay 112u is set to ON, the processing proceeds to step S102.

### Step S102

When switching the connection state from the first connection state to the second connection state, the first opening unit 511 sets the first relay that is set to ON in the first connection state, to OFF (step S102). The first relay that is set to ON in the first connection state is the relay 112u. For this reason, the first opening unit 511 transmits a switching signal SS indicating that the relay 112u that is set to ON in the first connection state is to be set to OFF, to the control circuit 103u. Upon receiving the switching signal SS, the control circuit 103u sets the relay 112u of the switching circuit 104u to OFF. The position at which a transition occurs from state 1 to state 2 in the timing chart shown in FIG. 5 indicates this state. When the relay 112u is set to OFF, the processing proceeds to step S103.

### Step S103

After the elapse of the first predetermined period Dt1 from when the first relay is set to OFF, the first connection unit 512 sets the second relay that was set to OFF in the first connection state, to ON. First, the first opening unit 511 sets the relay 112u to OFF, and then the first connection unit 512 waits for the first predetermined period Dt1. More specifically, for example, if the control device 50 has a timer, the first connection unit 512 sets a value representing the first predetermined period Dt1 in the timer and starts the timer. The timer value is decremented, for example, every 1 ms, and standby is performed until the timer value becomes zero (NO in step S103). Then, when the timer value becomes zero (YES in step S103), the control device 50 proceeds to step S104. The position of state 2 in the timing chart shown in FIG. 5 indicates this state.

### Step S104

Next, after the elapse of the first predetermined period Dt1, the first connection unit 512 switches the second relay that is set to OFF in the first connected state, to the connection state (step S104). Since the second relay that is set to OFF in the first connection state is the relay 111u, the first connection unit 512 transmits a switching signal SS indicating that the relay 111u is to be set to ON, to the control circuit 103u. Upon receiving the switching signal SS, the control circuit 103u sets the relay 111u to OFF. As a result, the connection state of the windings 21u and 22u is set to the second connection state. The position at which a transition occurs from state 2 to state 3 in the timing chart of FIG. 5 indicates this state. When the relay 111u is set to ON, the processing proceeds to step S105.

### Step S105

Next, a case will be described in which the connection state of the windings is switched from the second connection state to the first connection state. It is assumed that the second relay has already been set to ON by the first connection unit 512. When switching from the second connection state to the first connection state, the second opening unit 513 sets the second relay that has been set to ON by the first connection unit, to OFF (step S105). The second relay that was set to ON by the first connection unit is the relay 111u. Accordingly, the second opening unit 513 transmits a switching signal SS indicating that the relay 111u that has been set to ON by the first connection unit 512 is to be set to OFF, to the control circuit 103u. Upon receiving the switching signal SS, the control circuit 103u sets the relay 111u of the switching circuit 104u to OFF. The position at which a transition occurs from state 3 to state 4 in the timing chart of FIG. 5 indicates this state. The relay 111u is set to OFF, and the processing proceeds to step S106.

### Step S106

Next, after the elapse of the second predetermined period Dt2 from when the second relay is set to OFF, the second connection unit 514 sets the first relay to ON (step S106). After the second relay is set to OFF, that is, after the relay 111u is set to OFF, the second connection unit 514 waits for the second predetermined period Dt2 (NO in step S106). The position of state 4 in the timing chart of FIG. 5 indicates this state. Then, after the elapse of the second predetermined period Dt2 (YES in step S106), the processing proceeds to step S107.

### Step S107

After the elapse of the second predetermined period Dt2, the second connection unit 514 transmits a switching signal SS indicating that the relay 112u is to be set to ON, to the control circuit 103u. Upon receiving the switching signal SS, the control circuit 103u sets the relay 112u to ON (step S107). As a result, the connection state of the windings 21u and 22u is set to the first connection state.

As described above, when the connection state of the windings is switched between the first connection state and the second connection state, all relays that switch the connection state of the windings are first set to OFF, and then the connection state of the windings is switched. This prevents the windings from short-circuiting even when a plurality of relays are used, and suppresses the risk of a large induced current, a torque fluctuation, and contact sticking due to a large current.

### 2. Second Embodiment

In the winding switching device according to the second embodiment, a control circuit is constituted by a plurality of logic circuits.

### 2-1. Configuration of Winding Switching Device

FIG. 6 is a circuit diagram of an example of a control circuit 103u that is constituted by a plurality of logic circuits. The control circuit 103u receives the switching signal SS sent by the control device 50. The received switching signal SS (communication line 102) is input to a delay circuit 61, a NAND circuit 62, and an OR circuit 63. The delay circuit 61 to which the switching signal SS is input delays the switching signal SS by a delay time Dt3, and outputs a delayed switching signal 102d. The delay time Dt3 is, for example, 20 ms. The delay circuit 61 is constituted of, for example, a row of inverters connected serially. The switching signal SS (102) and the delayed switching signal 102d are input to a NAND circuit 62 and an OR circuit 63.

An output 102n and of the NAND circuit 62 is input to the gate of a P-type MOSFET 64. An output 102 or of the OR circuit 63 is input to the gate of a P-type MOSFET 65. Hereinafter, a P-type MOSFET is referred to as a PMOS in some cases. The sources of the PMOSs 64 and 65 are connected to a power source. The drains of the PMOSs 64 and 65 (relay drive signals 111ui and 112ui) leave the control circuit 103u and enter the switching circuit 104u. The PMOS transistors formed as shown in FIG. 6 are set to a conducting state when a LOW level is input to the gate, and the relay drive signals 111ui and 112ui become HIGH level.

The relay drive signal 111ui input to the switching circuit 104u is connected to a first terminal of the input (electromagnetic coil) of the relay 111u. The relay drive signal 112ui is connected to a first terminal of the input (electromagnetic coil) of the relay 112u. The second terminals of the relays 111u and 112u are connected to ground. When the relay drive signal 111ui becomes HIGH level, the relay 111u is set to ON. When the relay drive signal 112ui becomes HIGH level, the relay 112u is set to ON.

Diodes 66 and 67 may be connected in parallel to the inputs (electromagnetic coils) of the relays 111u and 112u. When the PMOSs 64 and 65 interrupt the current, there is a risk that the relay drive signals 111ui and 112ui2 will suddenly drop below the LOW level due to the magnetic energy stored in the electromagnetic coils at the inputs of the relays 111u and 112u, and the PMOSs 64 and 65 will be damaged. The diodes 66 and 67 are connected to absorb this magnetic energy.

### 2-2. Operation of Winding Switching Device

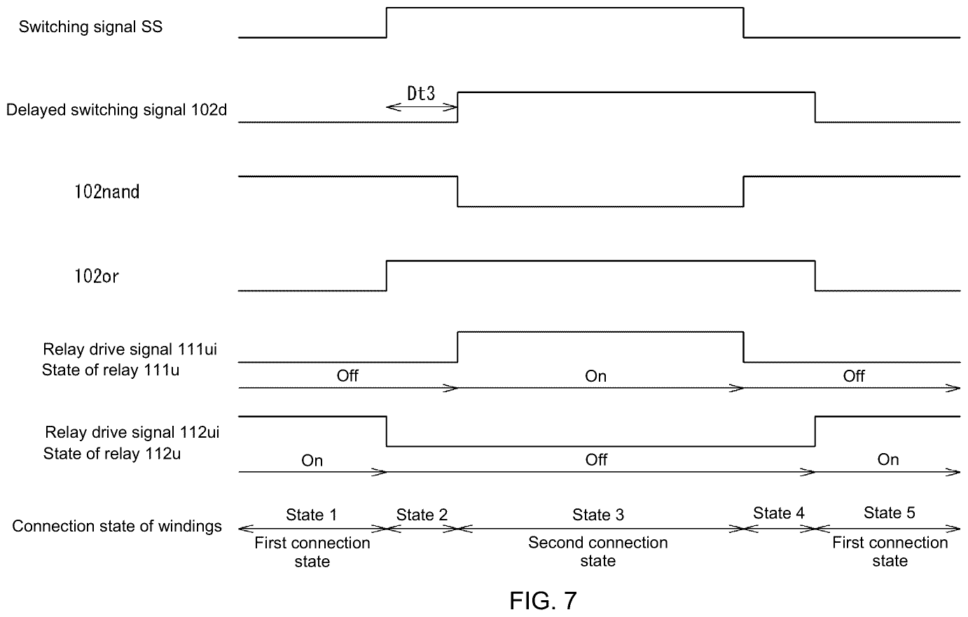

FIG. 7 is a timing chart showing an example of the operation of the winding switching device according to the second embodiment. The operation of the winding switching device 100 will now be described.

For example, at the start time of the winding switching processing, the control device 50 outputs “0” as the switching signal SS so as to set the connection state of the windings to the first connection state. Hereinafter, “0” means LOW level and “1” means HIGH level. Since the switching signal SS is “0”, the delayed switching signal 102d is also “0”. The NAND circuit 62 and the OR circuit 63 receive input of the switching signal SS of “0” and the delayed switching signal 102d of “0”. For this reason, the output 102n and of the NAND circuit 62 becomes “1”, and the output of the OR circuit 63 becomes “0”. Since the gate of the PMOS 64 is connected to the output 102n and of the NAND circuit 62, the gate of the PMOS 65 becomes “1”, that is, HIGH level, and the PMOS 64 turns off. Note that the LOW level is, for example, the potential of the body of the vehicle, and the HIGH level is, for example, the potential of the power source supplied to the control device 50.

On the other hand, since the output 102 or of the OR circuit 63 is connected to the gate of the PMOS 65, the gate of the PMOS 65 becomes “0”, that is, LOW level, and the PMOS 65 is set to a conducting state. Since the PMOS 64 is set to a non-conducting state, the relay drive signal 111ui becomes “0” and the relay 111u is set to OFF. On the other hand, since the PMOS 65 is set to the conducting state, the relay drive signal 112ui becomes “1” and the relay 111u is set to ON. Since the relay 111u is set to OFF and the relay 112u is set to ON, the windings 21u and 22u of the motor 20 are connected in the first connection state. Similarly, the V-phase and W-phase windings 21v, 22v, 21w, and 22w are connected in the first connection state. The position of state 1 in the timing chart shown in FIG. 7 indicates this state.

Next, the control device 50 switches the switching signal SS from “0” to “1” in order to switch the connection state of the windings to the second connection state. The switching signal SS immediately transitions from “0” to “1”, but the delayed switching signal 102d, which is a signal obtained by delaying the switching signal SS, remains at “0”. The NAND circuit 62 and the OR circuit 63 receive input of the switching signal SS of “1” and the delayed switching signal 102d of “0”. For this reason, the output 102n and of the NAND circuit 62 becomes “1”, and the output of the OR circuit 63 becomes “1”. Due to the output of the OR circuit 63 transitioning from “0” to “1”, the PMOS 65 transitions to a non-conducting state. That is, the OR circuit 63 functions as a first opening unit. Then, both of the PMOSs 64 and 65 are in the non-conducting state, the relays 111u and 112u are set to OFF, and the windings 21u and 22u are in an open state with one end not connected to anything. As a result, both of the relays 111u and 112u are set to ON, thereby suppressing generation of a large induced current caused by the winding 21u short-circuiting. The position of state 2 in the timing chart shown in FIG. 7 indicates this state.

Next, after the elapse of the delay time Dt3 of the delay circuit 61, the delayed switching signal 102d transitions from “0” to “1”. Accordingly, the NAND circuit 62 and the OR circuit 63 receive input of the switching signal SS of “l” and the delayed switching signal 102d of “1”. As a result, the output 102n and of the NAND circuit 62 transitions to “0”, and the PMOS 64 is set to the conducting state. Then, the relay drive signal 111ui transitions to “1” and the relay 11u is set to ON. That is, the NAND circuit 62 functions as a first connection unit. On the other hand, the output of the OR circuit 63 remains “1”. Accordingly, the PMOS 65 remains in the non-conducting state, the relay drive signal 112ui remains at “0”, and the relay 112u remains OFF. This causes the connection state of the windings 21u and 22u to transition to the second connection state. The position of state 3 in the timing chart of FIG. 7 indicates this state.

Next, in order to switch the connection state of the windings from the second connection state to the first connection state, the control device 50 switches the switching signal SS from “1” to “0”. The switching signal SS immediately transitions from “1” to “0”, but the delayed switching signal 102d, which is a signal obtained by delaying the switching signal SS, remains at “1”. The NAND circuit 62 and the OR circuit 63 receive input of the switching signal SS of “0” and the delayed switching signal 102d of “1”. For this reason, the output 102n and of the NAND circuit 62 immediately transitions to “1”. Due to the output of the NAND circuit 62 transitioning from “0” to “1”, the PMOS 64 transitions to the non-conducting state. That is, the NAND circuit 62 functions as a second opening unit. On the other hand, the output of the OR circuit 63 remains at “1”. As a result, both of the PMOSs 64 and 65 are in the non-conducting state, the relays 111u and 112u are set to OFF, and the windings 21u and 22u are in an open state with one end not connected to anything. Accordingly, both of the relays 111u and 112u are set to ON, thereby suppressing generation of a large induced current caused by the winding 21u short-circuiting. The position of state 4 in the timing chart shown in FIG. 7 indicates this state.

Next, after the elapse of the delay time Dt3 of the delay circuit 61, the delayed switching signal 102d transitions from “1” to “0”. Accompanying this, the NAND circuit 62 and the OR circuit 63 receive input of the switching signal SS of “0” and the delayed switching signal 102d of “0”. For this reason, the output 102n and of the NAND circuit 62 remains at “1”, the PMOS 64 remains in the non-conducting state, the relay drive signal 111ui remains at “0”, and the relay 111u remains OFF. On the other hand, the output of the OR circuit 63 transitions to “0”. As a result, the PMOS 65 is set to the conducting state, the relay drive signal 112ui transitions to “1”, and the relay 112u transitions to ON. That is, the OR circuit 63 functions as a second connection unit. This causes the connection state of the windings 21u and 22u to transition to the first connection state. The position of state 5 in the timing chart shown in FIG. 7 indicates this state.

As a result, even if the switching signal SS transitions from “0” to “1” and the connection state of the windings transitions from the first connection state to the second connection state, or if the switching signal SS transitions from “1” to “0” and the connection state of the windings transitions from the second connection state to the first connection state, the connection state of the relays 111u and 112u is switched with a period in between during which they are both OFF. Accordingly, the windings will not short-circuit. This prevents the windings from short-circuiting even when a plurality of relays are used, and suppresses the risk of a large induced current, a torque fluctuation, and contact sticking due to a large current.

### 3. Third Embodiment

A vehicle motor driving system of a third embodiment includes an AC motor in which stators for respective phases include a plurality of windings, the AC motor driving wheels of a vehicle, a power converter that converts DC power into three-phase AC power that drives the AC motor, and a winding switching system that switches the connection state of the plurality of windings.

The AC motor that drives the wheels of the vehicle is a traveling motor 20 that generates propulsive force for the electric vehicle. That is, the motor 20 is a drive motor that is connected to wheels 60 and drives the wheels 60. The motor 20 is driven by three-phase AC power. The motor 20 includes stators for the respective phases that include a plurality of windings. The characteristics of the motor 20 can be changed by switching between the plurality of windings.

The power converter 30 is an inverter that converts DC power supplied from the battery 40 into three-phase AC power. The power converter 30 includes a leg for each phase. The leg for each phase includes a switch. The switches perform switching to convert DC power into three-phase AC power.

The winding switching system 10 switches the connection state of a plurality of windings of a motor in which the stator of each phase includes the plurality of windings. The winding switching system 10 includes a first relay, a second relay, a first opening unit, a first determination unit, and a first connection unit. The first relay is set to ON when the connection state of the plurality of windings is a first connection state. The second relay is set to OFF when the connection state of the plurality of windings is the first connection state. The first opening unit sets the first relay to OFF when switching the connection state from the first connection state to the second connection state. The first connection unit sets the second relay to ON after the elapse of a first predetermined period from when the first relay is set to OFF.

As described in the first embodiment as well, due to the winding switching system 10 having such a configuration, when the connection state of the windings is switched, the winding switching system 10 first sets all relays to OFF, and then switches the connection state of the windings. This prevents the windings from short-circuiting even when a plurality of relays are used, and can suppress the risk of a large induced current, a torque fluctuation, and contact sticking due to a large current. Even in a vehicle equipped with such a winding switching system 10, it is possible to prevent a plurality of relays from entering the ON state at the same time.

### 4. Modified Examples

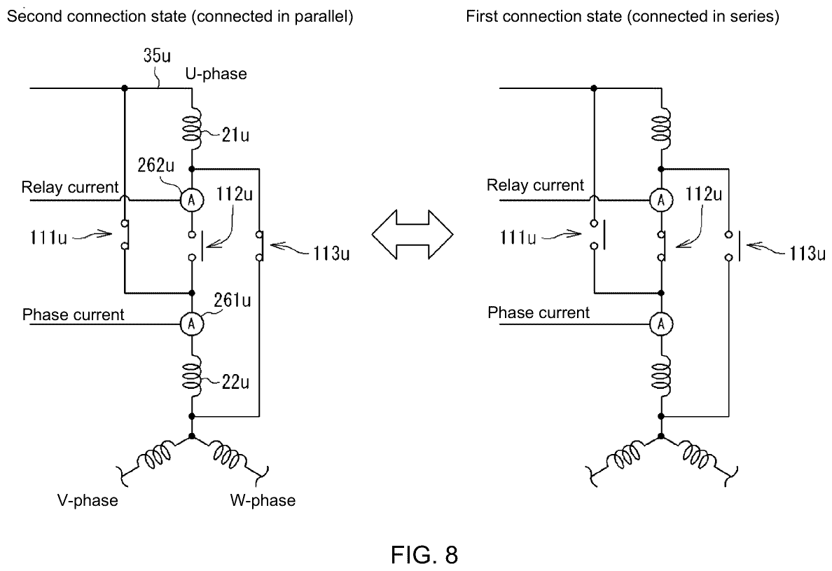

FIG. 8 is a circuit diagram showing an example of a configuration of a modified example of the winding switching device 100. FIG. 8 shows only the U-phase, but the same applies to the V-phase and the W-phase as well. Compared to the first embodiment, a relay 113u is added. The relay 113u is set to ON or OFF at the same timing as the relay 111u. The addition of relay 113u allows the winding 21u and the winding 22u to be connected in parallel. Hereinafter, the connection state of being connected in parallel is one type of the second connection state. When connected in parallel, the relays 111u and 113u are set to ON, and the relay 112u is set to OFF. On the other hand, in the case of a series connection, the relays 111u and 113u are set to OFF, and the relay 112u is set to ON.

The winding switching device 100 switches the connection state of the windings of the motor 20 from a first connection state in which the windings are connected in series to a second connection state in which the windings are connected in parallel. Alternatively, the connection state is switched from the second connection state in which the windings are connected in parallel to the first connection state in which the windings are connected in series. In this case as well, the connection state of the windings is switched after a state in which all of the relays are set to OFF. This prevents the windings from short-circuiting even when a plurality of relays are used, and suppresses the risk of a large induced current, a torque fluctuation, and contact sticking due to a large current.

### 5. Supplementary Note

The embodiments disclosed herein are illustrative in all respects and are not restrictive. The scope of the present invention is indicated not by the above-described embodiments but by the claims, and encompasses all modifications within the meaning and range equivalent to the claims. In addition, although a vehicle motor has been described as an example, there is no limitation to a vehicle motor, and the present invention is applicable to an AC motor in which a plurality of windings are switched by a plurality of relays to change the characteristics.

1. A winding switching system for, in a motor in which stators for respective phases each include a plurality of windings, switching a connection state of the plurality of windings, comprising:
a first relay that is set to ON when the connection state of the plurality of windings is a first connection state;
a second relay that is set to OFF when the connection state of the plurality of windings is the first connection state;
a first opening unit configured to set the first relay to OFF when switching the connection state from the first connection state to a second connection state; and
a first connection unit that sets the second relay to ON after the elapse of a first predetermined period from when the first relay is set to OFF by the first opening unit.

2. The winding switching system according to claim 1, wherein the first predetermined period is longer than a reset time of the first relay.

3. The winding switching system according to claim 1, further including;
a second opening unit configured to set the second relay to OFF when switching the connection state from the second connection state to the first connection state; and
a second connection unit configured to set the first relay to ON after the elapse of a second predetermined period from when the second relay is set to OFF by the second opening unit.

4. The winding switching system according to claim 3, wherein the second predetermined period is longer than a reset time of the second relay.

5. The winding switching system according to claim 1,
wherein the plurality of windings includes a first winding and a second winding,
a first terminal of the first relay is connected to a first terminal of the first winding,
a second terminal of the first relay is connected to a first terminal of the second winding,
a first terminal of the second relay is connected to the first terminal of the second winding, and
a second terminal of the second relay is connected to a second terminal of the first winding.

6. The winding switching system according to claim 5, further including:
a third relay that is set to ON when the connection state of the plurality of windings is the first connection state,
wherein a first terminal of the third relay is connected to the second terminal of the first winding,
a second terminal of the third relay is connected to a second terminal of the second winding, and
the first opening unit sets the third relay to OFF when switching the connection state from the first connection state to the second connection state.

7. The winding switching system according to claim 1,
wherein when a drive device configured to drive the motor suppresses a current that drives the motor,
the first opening unit sets the first relay to OFF, and
the first connection unit sets the second relay to ON.

8. The winding switching system according to claim 3,
wherein when a drive device configured to drive the motor suppresses a current that drives the motor,
the second opening unit sets the second relay to OFF, and
the second connection unit sets the first relay to ON.

9. A vehicle motor drive system comprising:
an AC motor in which stators for respective phases each include a plurality of windings, the AC motor being configured to drive wheels of a vehicle;
a power converter configured to convert DC power into three-phase AC power for driving the AC motor; and
the winding switching system according to any one of claims 1 to 8, configured to switch a connection state of the plurality of windings.

10. A control device for controlling a winding switching device that includes a first relay and a second relay and is for, in a motor in which stators for respective phases each include a plurality of windings, switching a connection state of the plurality of windings, comprising:
an opening unit configured to set the first relay that is set to ON when the connection state of the plurality of windings is a first connection state, to OFF when switching from the first connection state to a second connection state; and
a connection unit configured to set the second relay that is set to OFF when the connection state of the plurality of windings is the first connection state, to ON after the elapse of a predetermined period from when the first relay is set to OFF.

11. A control method for controlling a winding switching device that includes a first relay and a second relay and is for, in a motor in which stators for respective phases each include a plurality of windings, switching a connection state of the plurality of windings, comprising:
a step of setting the first relay that is set to ON when the connection state of the plurality of windings is a first connection state, to OFF when switching from the first connection state to a second connection state; and
a step of setting the second relay that is set to OFF when the connection state of the plurality of windings is the first connection state, to ON after the elapse of a predetermined period from when the first relay is set to OFF.

12. A computer program used by a control device for controlling a winding switching device for, in a motor in which stators for respective phases each include a plurality of windings and a connection state of the plurality of windings can be switched, switching the connection state of the plurality of windings using a first relay and a second relay, the computer program being used to cause a computer to execute:
a step of setting the first relay that is set to ON when the connection state of the plurality of windings is a first connection state, to OFF when switching from the first connection state to a second connection state; and
a step of setting the second relay that is set to OFF when the connection state of the plurality of windings is the first connection state, to ON after the elapse of a predetermined period from when the first relay is set to OFF.
